(19) United States
(12) Patent Application Publication
(10) Pub. No.: US 2021/0117970 A1
(43) Pub. Date: Apr. 22, 2021

(54) CORROBORATING DATA TO VERIFY TRANSACTIONS

(71) Applicant: YUPP TECHNOLOGY INC., Toronto (CA)

(72) Inventors: Justin Hugh, Toronto (CA); Connor Fowlie, Toronto (CA)

(21) Appl. No.: 16/970,061

(22) PCT Filed: Feb. 11, 2019
(86) PCT No.: PCT/IB2019/051084

§ 371 Date: Aug. 14, 2020

Related U.S. Application Data
(60) Provisional application No. 62/630,296, filed on Feb. 14, 2018.

(51) Int. Cl. G06Q 20/40; G06Q 20/20

(52) U.S. Cl. CPC G06Q 20/401; G06Q 20/4016; G06Q 20/20

(57) ABSTRACT

Methods for verifying a transaction and coordinating verification of a transaction are provided. A method for verifying a transaction involves obtaining transaction data indicating execution of a transaction. The transaction data includes payment parameters of the transaction. The method involves obtaining corroborating data relevant to a determination of whether the transaction is determined to be authentic or inauthentic, displaying the payment parameters and indications of the corroborating data through a user interface of a computing device, and receiving a selection through the user interface to indicate that the transaction is determined to be authentic or inauthentic. A method for coordinating verification of a transaction involves obtaining transaction data, transmitting the transaction data to a user device, and receiving a selection from the user device to indicate whether the transaction is determined to be authentic or inauthentic. The methods may be embodied in non-transitory computer-readable media and executed by computing devices.

### FIELD

The present disclosure relates generally to information systems, and in particular to transaction verification systems.

### BACKGROUND

The payment services industry is becoming increasingly reliant on computer infrastructure to coordinate transactions. A computerized payment service may process a large volumes of legitimate transactions on a routine basis without incident. However, payment services are nevertheless at risk of processing at least some fraudulent transactions without notice by the payment service or by the person purported to have made the transaction. Automated fraud detection systems may not be capable of identifying some transactions as fraudulent.

### SUMMARY

A transaction may be verified by a user who has the benefit of corroborating data which assists in determining whether the transaction is authentic or inauthentic. The user may be presented with transaction data describing a potentially fraudulent transaction along with corroborating data which may indicate to the user whether or not the transaction is determined to be authentic. The corroborating data may include contextual information to remind the user about the transaction and its relevant details. The user may operate a computing device to view transaction data, corroborating data, and to make a determination as to the transaction's authenticity. The computing device may communicate with a payment verification coordination server which coordinates the obtention of transaction data and provision of the transaction data to the computing device for verification.

Thus, according to an aspect of the specification, a method to verify a transaction is provided. The method involves obtaining transaction data indicating execution of a transaction. The transaction data includes payment parameters of the transaction. The method further involves obtaining corroborating data relevant to a determination of whether the transaction is authentic or inauthentic. The method further involves displaying the payment parameters and indications of the corroborating data through a user interface of a computing device. The method further involves receiving a selection through the user interface to indicate that the transaction is determined to be authentic or inauthentic. The method may be embodied by a set of executable instructions that may be stored in a non-transitory computer-readable medium. The instructions may be incorporated into a transaction verification software application. The instructions may be executed by a computing device such as a user's mobile computing device.

According to another aspect of the specification, a method to coordinate verification of authenticity of a transaction is provided. The method involves obtaining transaction data indicating execution of a transaction. The transaction data includes payment parameters of the transaction. The method further involves transmitting the transaction data to a user device for display through a user interface of the user device. The user interface is to display the payment parameters and indications of corroborating data. The corroborating data is relevant to a determination of whether the transaction is authentic or inauthentic. The method further involves receiving a selection from the user device to indicate whether the transaction is determined to be authentic or inauthentic. The selection is made based at least in part on analysis of the corroborating data. The method may be embodied by a set of executable instructions that may be stored in a non-transitory computer-readable medium. The instructions may be executed by a computing device such as a transaction verification coordination server.

### BRIEF DESCRIPTION OF THE DRAWINGS

FIG. 1 is a schematic diagram of an example computing device including a user interface and set of instructions to verify a transaction.

FIG. 2 is a flowchart of an example method for verifying a transaction.

FIG. 3 is a flowchart of an example method for coordinating verification of a transaction.

FIG. 4 is a schematic diagram of an example system for verifying a transaction.

FIG. 5 illustrates an example user interface of a transaction verification application displaying location data to corroborate a transaction.

FIG. 6 illustrates an example user interface of a transaction verification application displaying a message to corroborate the transaction.

FIG. 7 illustrates an example user interface of a transaction verification application displaying a calendar event to corroborate the transaction.

FIG. 8 illustrates an example user interface of a transaction verification application displaying a listing of transactions.

FIG. 9 illustrates an example user interface of a transaction verification application displaying transactions pending verification.

FIG. 10 is a flowchart of an example method for verifying a transaction using a transaction verification application.

FIG. 11 is a flowchart of an example method for transmitting transaction data to a computing device running a transaction verification application.

FIG. 12 is a schematic diagram of another example system for verifying a transaction.

FIG. 13 is a schematic diagram of an example database structure of a system for verifying a transaction.

### DETAILED DESCRIPTION

Automated systems for detecting fraud in payment transactions may not have the benefit of sufficient contextual understanding to properly determine whether or not a transaction is authentic. However, a user provided with sufficient contextual information may be able to make such a determination more accurately.

A system may be provided in which transaction information is presented to a user along with contextual information to assist the user to determine whether or not the transaction is authentic. The contextual information may remind the user about the transaction or draw the user's attention to relevant details about the transaction so that the user may more easily recall the transaction and determine whether or not the transaction is authentic. An authentic transaction is one made and authorized by the user. An inauthentic transaction is one made fraudulently or in error. The user's determination may be used by information systems which coordinate responses to fraudulent payment activity. Payment processors and financial institutions may thereby benefit from greater reliability and financial certainty in payment processing.

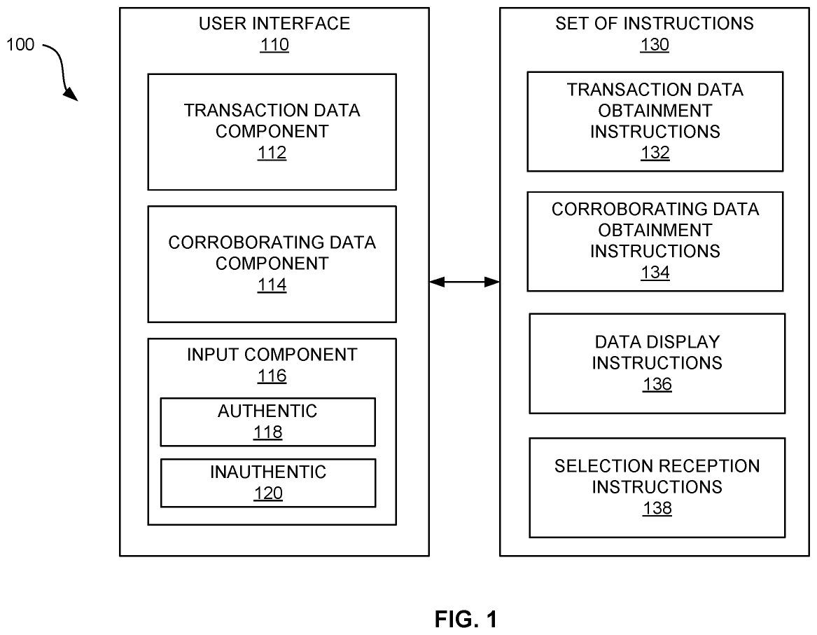

FIG. 1 is a schematic diagram of an example computing device 100. The computing device 100 may be a desktop computer, server, notebook computer, tablet computer, smartphone, or similar device. Thus, the computing device 100 includes a processor and memory to store programming instructions executable by the processor. The computing device 100 may be used to verify transactions. Such transactions may be made in person, e.g. by a user in possession of the computing device 100 at the time of purchase. Such transactions may also be made remotely, e.g. through an online store. In any event, the computing device 100 belongs to or is associated with a user who is able to verify transactions.

The computing device 100 includes a display and an input device to enable operation of a user interface 110. The user interface 110 may be generated by a software application, such as a transaction verification software application, which displays data and receives inputs from the user. In some examples, the display and input device may include a touch screen of a mobile computing device. In other examples, the display may be a computer monitor, television screen, or other screen, and the input device may be a mouse, keyboard, touch screen, or other input device.

The user interface 110 includes a transaction data component 112 to display transaction data or indications thereof and a corroborating data component 114 to display corroborating data or a display thereof. A user may thereby view and analyze the transaction data and corroborating data through the user interface 110. The user interface 110 further includes an input component 116 to receive a selection of whether the transaction is determined to be authentic or inauthentic. The input component 116 may include an authenticating button 118 and an inauthenticating button 120. A user may press the authenticating button 118 to indicate that the transaction is determined to be authentic, or press the inauthenticating button 120 to indicate that the transaction is determined to be inauthentic.

The components 112, 114, 116, and buttons 118, 120, need not be arranged in the configuration shown. In some examples, the components 112, 114, 116 and buttons 118, 120 may each be simultaneously displayed by the user interface 110. In other examples, one or more of the components 112, 114, 116 and buttons 118, 120 may be displayed asynchronously at other times from the other elements, or in different areas, such as on separate pages, slides, or in another visual display component. Further, the components 112, 114, 116, and buttons 118, 120 need not be distinct visual elements on the user interface 110. The transaction data, corroborating data, and/or buttons 118, 120 may be displayed together or overlapping in any manner. A component 112, 114, 116 or button 118, 120 may be generated or hidden dynamically according to any user experience scheme. For example, authenticating button 118 may be omitted where it is assumed that any transaction which is not indicated to be inauthentic is deemed to be authentic.

The computing device 100 further includes a set of instructions 130. The set of instructions 130 may be embodied by a set of executable instructions that may be stored in a non-transitory computer-readable medium, such as the memory of the computing device 100, and executed by a processor of the computing device 100. The set of instructions 130 may be incorporated into a software application for verifying transactions. Such a software application may generate the user interface 110.

The set of instructions 130 includes transaction data obtainment instructions 132. The transaction data obtainment instructions 132 are to obtain transaction data indicating execution of a transaction. The transaction data includes payment parameters of the transaction, such as an identifier of a product or service purchased, a purchase amount, an identifier of a merchant purported to have sold the product or service, a time of the transaction, a payment card used to make the transaction, or other details describing the transaction.

The set of instructions 130 includes corroborating data obtainment instructions 134. The corroborating data obtainment instructions 134 are to obtain corroborating data relevant to a determination of whether the transaction is authentic or inauthentic. The corroborating data may be obtained from memory, from software applications on the computing device 100, or from a remote source.

The set of instructions 130 includes data display instructions 136. The data display instructions 136 are to display the payment parameters and indications of the corroborating data through the user interface 110. Thus, the data display instructions 136 may display the transaction data in the transaction data component 112 and the corroborating data in the corroborating data component 114. The data display instructions 136 may arrange the transaction data and corroborating data for ease of comparison by the user.

The computing device 100 may further prompt the user to view the transaction data and corroborating data and to make a selection as to whether the transaction is determined to be authentic or inauthentic. Thus, the set of instructions 130 may further be to prompt the user of the computing device 100 to make a selection to indicate that the transaction is determined to be authentic or inauthentic. A prompt may be generated through the user interface 110. The prompt may be a pop-up which may appear when the computing device 100 is at its home screen or running another application.

The set of instructions 130 includes selection reception instructions 138. The selection reception instructions 138 are to receive a selection through the user interface 110 to indicate that the transaction is determined to be authentic or inauthentic. Thus, the selection reception instructions 138 may detect a press of the authenticating button 118 or inauthenticating button 120.

In response to receiving a selection, the computing device 100 may transmit the selection to a verifying entity or coordinating entity, such as a financial institution system, payment processor, a transaction verification coordination server, or other system.

The corroborating data may provide contextual information to assist the user to verify the transaction. For example, the corroborating data may include position data. For example, the transaction data may indicate that the transaction was executed at a particular point-of-sale device at a particular time. The corroborating data may include a location of the particular point-of-sale device, and a location of the computing device 100 at the particular time. The set of instructions 130 may be to display through the user interface 110 an indication of the location of the particular point-of-sale device and the location of the computing device at the particular time. Thus, a user may compare the location of the computing device 100 at the time of the purported purchase, and incorporate this information into a determination of whether or not the transaction is likely to be authentic. Further, the set of instructions 130 may further be to display through the user interface 110 an indication of whether the location the computing device 100 was proximate to the particular point-of-sale device at the particular time. Thus, the user interface 110 further assists the user in making a determination as to whether the transaction is authentic or not. Such corroborating data may be particularly useful for verifying purchases made through a point of sale device where position information is relevant.

As another example, the corroborating data may include a message. The message may have contents or metadata which corroborates a payment parameter of the transaction, and the set of instructions 130 may further be to display through the user interface 110 an indication of whether the contents or metadata of the message corroborate the transaction. For example, the message may include a transaction receipt which corroborates a payment amount of the transaction. For example, the message may include an electronic receipt which matches the payment parameters of the transaction. Such corroborating data may be particularly useful for verifying purchases made through online stores where position information is not relevant.

As another example, the corroborating data may include a calendar event. The calendar event may correspond to a time of execution of the transaction, and the calendar event may have contents or metadata which corroborates a payment parameter of the transaction. For example, the calendar event may include a subject line which matches an identifier of the product or service purchased, a name of the seller, or another payment parameter. Such corroborating data may be particularly useful for verifying purchases made at a particular place and time such as when at a pre-planned event such as a concert, convention, vacation, or other activity.

As another example, the corroborating data may include an image of a receipt generated from the transaction. An image of the receipt may be analyzed to identify text, and the text may be read to determine whether the text includes a payment parameter which corroborates the payment. Such analysis may be performed via optical character recognition, machine vision, and other image analysis techniques. Such analysis may be performed at the computing device 100 or remotely, such as at a transaction verification coordination server. The receipt may include text written thereon which indicates a payment amount which may correspond to the payment amount as indicated in the transaction data. This payment amount may be incorporated into the corroborating data and presented to the user. An indication that the payment amount on the receipt matches the payment amount in the transaction data may also be displayed, to aid the user in recognizing the match. Thus, the set of instructions 130 may further be to obtain an image of a receipt generated from the transaction, identify text on the receipt of the transaction, analyze the text on the receipt for a payment parameter on the receipt, and display through the user interface an indication of whether the payment parameter on the receipt corroborates a payment parameter of the transaction. In examples where the computing device 100 includes a camera, the set of instructions 130 may further be to, prior to obtaining the image of the receipt generated from the transaction, prompt a user of the computing device to capture the image using a camera of the computing device 100. Thus, the image of the receipt may be obtained using the computing device 100. In other examples, the image may be obtained from another source, such as an online storage of images of receipts, stored on a transaction verification coordination server or elsewhere, and analyzed at the computing device 100 or remotely such as at a transaction verification coordination server.

After selection of whether the transaction is determined to be authentic, the transaction may be categorized. Transactions may be categorized to be viewed by a user for budgetary or other analysis purposes. For example, an authorized transaction may count toward a budget in a budgeting tool. Such a budgeting tool may categorizes transactions based on purchasing category: groceries, transportation, entertainment, clothing, etc. Such a budgeting tool may be implemented via the set of instructions 130, or may be implemented as a separate software application on the computing device 100 accessible to the set of instructions 130. Further, the user may categorization transactions as a business expense or personal expense. Thus, users who make business and personal purchases using the same payment card may organize one's respective financial information.

Thus, the set of instructions 130 may further be to receive input through the user interface 110 to designate that the transaction belongs to a selected category of transactions. The set of instructions 130 may further be to display through the user interface 110 an indication that the transaction belongs to the selected category of transactions. Categorization of a transaction may be made prior to, after to, or concurrently with verification of authenticity of the transaction.

Further, after selection of whether the transaction is determined to be authentic, the transaction may be monitored for revisions. For example, a payment hold may be made against the user's financial account to authorize the user's payment card to be charged a certain payment amount. Such a hold may be a deposit on a rental item, an authorization for a fuel payment, and the like. The certain payment amount may not reflect an actual payment amount and may be expected to be revised to the actual amount at a later time. In such circumstances, the user may request a reminder for when a payment parameter of the transaction is revised. For example, the user may be reminded when the deposit is removed from one's account, or the hold for fuel payment is replaced with a purchase amount reflecting the amount paid for the fuel purchase. When a revision to a payment parameter of such a transaction is identified, the user may be prompted to verify the revision. A user may select that a transaction is to be monitored by pressing a button indicating such. Thus, the set of instructions 130 may further be to monitor transaction data for a revision to a payment parameter of the transaction, and in response to identifying a revision to the payment parameter, prompt the user of the computing device 100 to make a selection to indicate that the revision is determined to be authentic or inauthentic.

Further, after a selection that the transaction is determined to be inauthentic, the set of instructions 130 may further be to transmit a message to a verifying entity or coordinating entity, such as a financial institution system, payment processor, a transaction verification coordination server, or other system, to indicate that a selection that the transaction is inauthentic has been made. Moreover, the message may be a template message which may be sent by the user, and which may be modified or completed by the user. For example, the message may be an email template which may be completed by the user to provide additional details to the financial institution regarding the supposed fraud. In other examples, the message may be a message to be sent through a social media platform. Thus, the set of instructions 130 may further be to, in response to receiving a selection through the user interface 110 to indicate that the transaction is inauthentic, generate a template message directed to a financial institution system to indicate that a selection that the transaction is inauthentic has been made. A message which is written at least in part by the user may initiate more immediate action from the financial institution than an automated data transmission.

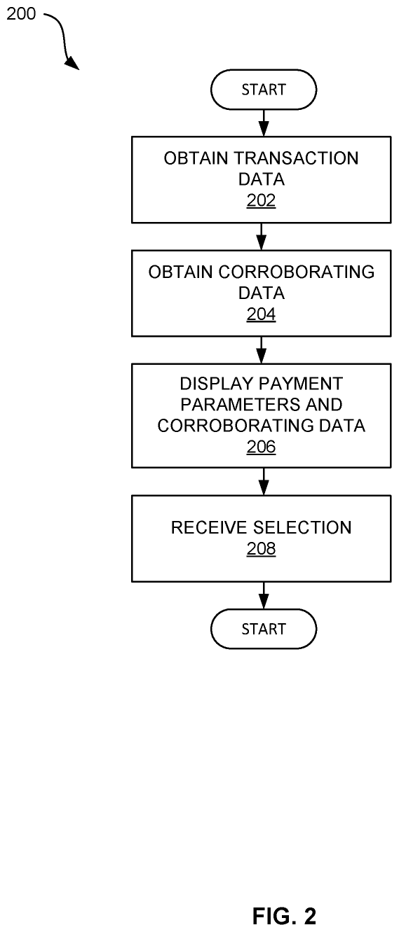

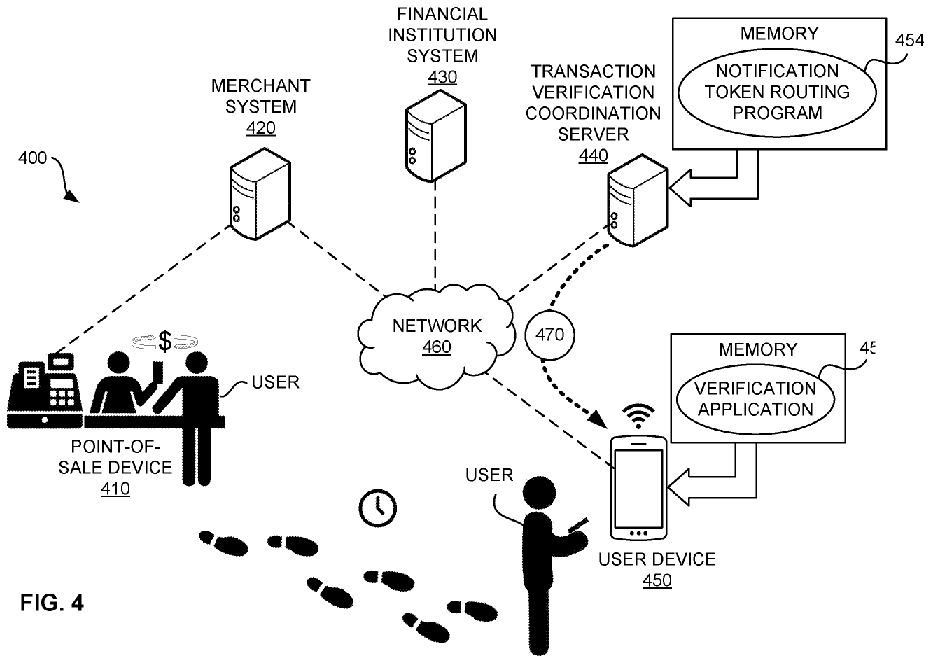

FIG. 2 is a flowchart of an example method 200 for verifying a transaction. The method 200 may be performed by a computing device as discussed herein, such as the computing device 100 of FIG. 1, or the user device 450 of FIG. 4. The method 200 may be embodied by a set of executable instructions that may be stored in a non-transitory computer-readable medium.

At block 202, transaction data is obtained. The transaction data indicates execution of a transaction. The transaction data includes payment parameters of the transactions. At block 204, corroborating data is obtained. The corroborating data is relevant to a determination of whether the transaction is authentic or inauthentic. At block 206, payment parameters and corroborating data are displayed. The payment parameters and corroborating data are displayed through a user interface of a computing device. The user interface of the computing device is operable by a user able to verify the transaction. At block 208, a selection of whether the transaction is determined to be authentic or inauthentic is received. The selection is received by user input through the user interface.

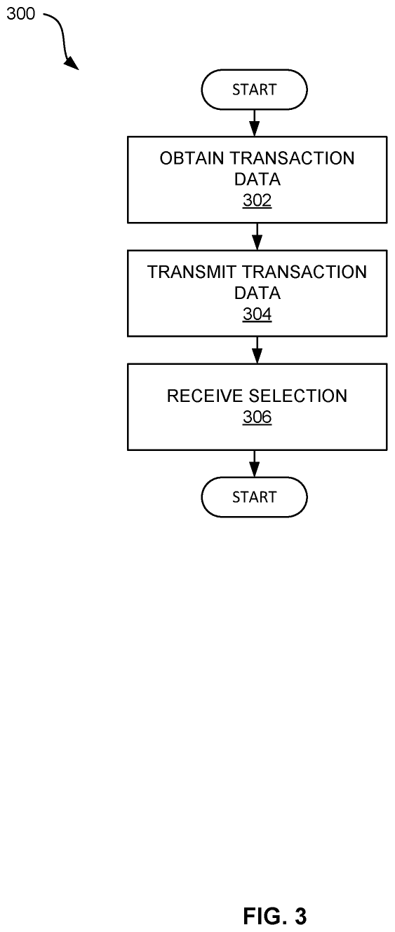

FIG. 3 is a flowchart of an example method 300 for coordinating verification of a transaction. The method 300 may be performed by a computing device as discussed herein, such as the transaction verification coordination server 440 of FIG. 4. The method 300 may be embodied by a set of executable instructions that may be stored in a non-transitory computer-readable medium.

At block 302, transaction data is obtained. The transaction data indicates execution of a transaction. The transaction data includes payment parameters of the transaction.

At block 304, transaction data is transmitted. The transaction data is transmitted to a user device for display through a user interface of the user device. The user interface is to display the payment parameters and indications of corroborating data, the corroborating data is relevant to a determination of whether the transaction is determined to be authentic or inauthentic. The user device may include a computing device as discussed herein, such as the computing device 100 of FIG. 1, or the user device 450 of FIG. 4. At block 306, a selection is received from the user device. The selection indicates whether the transaction is identified as authentic or inauthentic. The selection made based at least in part on analysis of the corroborating data by a user operating the user device.

In some examples, the method 300 may further involve obtaining the corroborating data and transmitting the corroborating data to the user device. Thus, the corroborating data may be provided by a source remote from the user device.

In some examples, the transaction data may be obtained from a financial institution system. For example, transaction data may be scraped from the financial institution system or pushed from the financial institution system. Further, the transaction data may be obtained through a webhook listener connected to the financial institution system.

FIG. 4 is a schematic diagram of an example system 400 for verifying transactions. The system 400 includes a point of sale device 410 which operates to complete a retail transaction between a user and a seller at a retail establishment. The point-of-sale device 410 may include a payment system having a credit or debit card reader, a semi-attended customer-activated terminal (SACAT), payment terminal, or other point-of-sale device. The point-of-sale device 410 is in communication with a merchant system 420 which processes payments made by the point-of-sale device 410, which authenticates, authorizes, and completes payment between the retailer and a financial institution making a payment on behalf of the user.

The system 400 further includes a financial institution system 430, which operates to manage financial accounts, including a financial account held by the user. The financial institution system 430 may include a computing system of a bank, trust company, insurance company, brokerage firm, investment dealer, stock exchange, fiat currency exchange, cryptocurrency exchange, or any other payment agent which facilitates financial transactions between consumers and businesses or between companies.

The system 400 further includes a transaction verification coordination server 440, which runs a notification token routing program 454 including programming instructions for executing the methods described herein to coordinate verification of transactions. The transaction verification coordination server 440 includes a communication interface to send and receive such data, including transaction data, selections of whether a transaction is determined to be authentic or inauthentic, and in some examples corroborating data.

The system 400 further includes a user device 450, operable by the user, to communicate with the transaction verification coordination server 440 to verify transactions, as set out in the methods described herein. The user device 450 may be similar to the computing device 100 of FIG. 1, and thus, for further description, reference may be had to the computing device 100 of FIG. 1.

The merchant system 420, financial institution system 430, transaction verification coordination server 440, and user device 450 are in communication over one or more computer networks, indicated as network 460. The network 460 may include the internet, a Wi-Fi network, a local-area network, a wide-area network (WAN), a wireless cellular data network, a virtual private network (VPN), a combination of such, and similar.

The merchant system 420, financial institution system 430, and transaction verification coordination server 440, each include a computing device running a server application with storage, communication, and processing means.

Although shown as singular servers, the systems 420, 430, and server 440 may refer to a combination of computers and/or servers, such as in a cloud computing environment.

The user device 450 may be a mobile computing device. The user device 450 has storage, communication, and processing means. The user device 450 runs a verification application 452 to verify transactions. The user device 450 may verify transactions in coordination with the transaction verification coordination server 440. The user device 450 may include a graphical display surface, such as an LCD, OLED, or other display, and an input device such as a touchscreen, for displaying and interacting with a user interface and software applications. Such a display and input device may enable a user of the user device 450 to interact with a user interface generated thereon. In some examples, the user device 450 may be a smart phone. In other examples, user device 450 may be a desktop computer, a tablet computer, a laptop, a desktop computer, or similar.

The merchant system 420, financial institution system 430, transaction verification coordination server 440, and user device 450 may each include a processor, network interface, and memory. The processors may include any quantity and combination of a processor, a central processing unit (CPU), a microprocessor, a microcontroller, a field-programmable gate array (FPGA), and similar. The network interfaces may include programming logic enabling the system or device to communicate over network 460, may be configured for bidirectional data communications through the network 460, and accordingly may include a network adaptor and driver suitable for the type of network used. The memory may include volatile storage and non-volatile storage. Volatile storage may include random-access memory (RAM) or similar. Non-volatile storage may include a hard drive, flash memory, and similar.

In operation, after a user makes a transaction, such as at point-of-sale device 410, the transaction is authenticated by merchant system 420 and recorded at financial institution system 430. The financial institution system 430 may designate all, or only a portion, of transactions for verification by the transaction verification coordination server 440.

The transaction verification coordination server 440 may scrape for transaction data stored at the financial institution system 430, or may be pushed transaction data from the financial institution system 430. The transaction verification coordination server 440 may compile such transaction data relating to one or more transactions into a request token 470 to be transmitted to the user device 450 for verification by the user. In some examples, the request token 470 may include corroborating data. The corroborating data may provide contextual information to assist the user to verify the transaction. In other examples, corroborating data may be obtained by or at the user device 450. Further, some corroborating data may be provide by the transaction verification coordination server 440 while other corroborating data is provided by the user device 450.

Corroborating data is displayed to the user through verification application 452 so that the user may assess the transaction in a more contextually rich environment. This information may be sufficient for the user to recognize the transaction as legitimate or likely to be fraudulent. Thus, the user device 450 may include a locating device such as a GPS to record position information as corroborating data which may be useful for verifying transactions as described herein. Further, the user device 450 may run an email or other messaging application for receiving messages which may also be useful for verifying transactions as described herein. Further, the user device 450 may run a calendar or other planning application in which events may be created and viewed, which may also be useful for verifying transactions as described herein. Further, the user device 450 may include a camera which may be used to capture an image of a receipt which may be useful for verifying transactions as described herein.

Upon making a determination as to the authenticity of the transaction, the user may use the verification application 452 to either confirm the transaction as authentic or flag the transaction as inauthentic. The verification application 452 may then and transmit such response to the transaction verification coordination server 440. Having received a response from the user device 450, the transaction verification coordination server 440 may coordinate with the financial institution system 430 to reflect such information at the user's financial account. The information may be used to begin or to inform a fraud investigation.

The transaction verification coordination server 440 may also have the benefit of access to uniquely reliable transaction data that has been vetted by users themselves. Such reliable transaction data may be used to generate a targeted advertisement based on the transaction data.

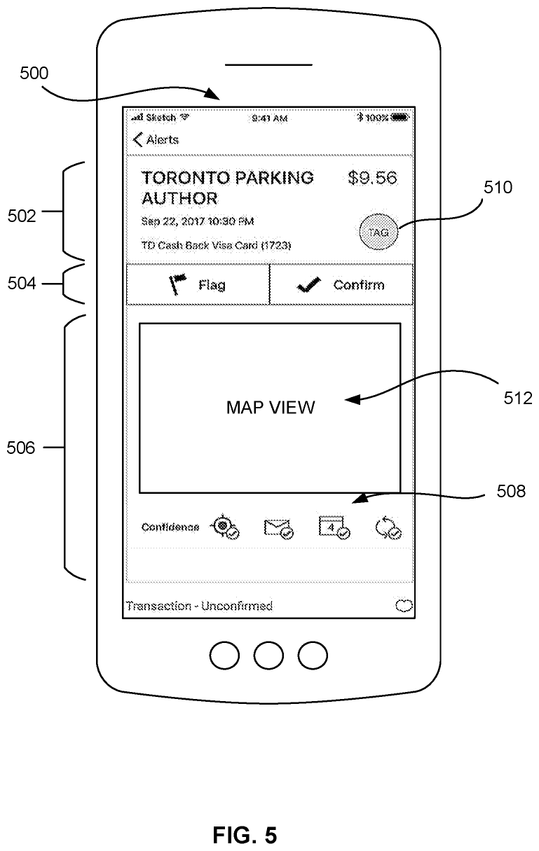

FIG. 5 illustrates an example user interface 500 of a transaction verification application displaying location data to corroborate a transaction. The transaction verification application generates a user interface 500 for display on a computing device such as the computing device 100 of FIG. 1 or the user device 450 of FIG. 4. The user interface 500 includes a transaction data component 502 which is to display transaction data, such as the identity of the merchant making the charge, the transaction amount, the data and time of the transaction, and the financial account to which a particular transaction is being charged.

The user interface 500 further includes a corroborating data component 506. In this example, the corroborating data component 506 is to display a map 512 indicating the geolocation of a point-of-sale device at which the transaction is purported to have been made. In some examples, the map 512 may display a location of both the computing device at the time of transaction and a point-of-sale device at which the transaction is purported to have been made. The corroborating data component 506 is also to display indicators 508 of whether or not corroborating data supports authenticity of the transaction.

An indicator 508 may include a position indicator to indicate whether a position of the computing device supports a determination that the transaction is authentic. For example, the position indicator may show a checkmark or other positive indication that the computing device was in the relevant location at the time of purchase. In other words, where a record of the user's geolocation data, to which the verification application has access, is in proximity in time to a timestamp of the transaction, and is in concurrent proximity in location to a supposed point-of-sale device purported to have executed the transaction, an indicator 508 may display a geolocation icon with a checkmark indicating that the transaction can be corroborated by a geolocation dataset.

An indicator 508 may include a message indicator to indicate whether a message supports a determination that the transaction is authentic. For example, the verification application may have accessed a message, such as an email, social media post or message, or other message, which includes an electronic receipt or other content which verifies the payment amount of the transaction. In other words, where a user's email account data, to which the verification application has access, includes a receipt, or transaction confirmation, corresponding to the transaction, including timestamp and purchase amount corresponding to the transaction, an indicator 508 may display an email icon with a checkmark indicating that the transaction can be corroborated by an email dataset. Identification that the contents of a message constitutes corroboration of a transaction may be through analysis of the text of the message using a text parser, natural language processor, and/or machine learning model trained to recognize transaction information.

An indicator 508 may include a calendar indicator to indicate whether a calendar event supports a determination that the transaction is authentic. For example, the verification application may have accessed a calendar invite which corroborates a place, time, or subject of the purchase.

An indicator 508 may include a recurring payment indicator to indicate whether a recurring payment supports a determination that the transaction is authentic. For example, the verification application may have accessed previous payments of a similar nature which have previously been verified as authentic, such as a recurring bill payment.

The user interface 500 includes an input component 504 to receive a selection that the transaction is determined to be authentic or inauthentic. The input component 504 includes a “flag” button which a user may press to select that the transaction is determined to be inauthentic and a “confirm” button which the user may press to select that the transaction is determined to be authentic.

The user interface 500 further includes a categorization component 510 to categorize the transaction as belonging to one or more of a plurality of categories. The categorization component 510 may include a “tag” button, which a user may press to categorize the transaction, or to generate a categorization window or other visual element from which a particular category may be selected.

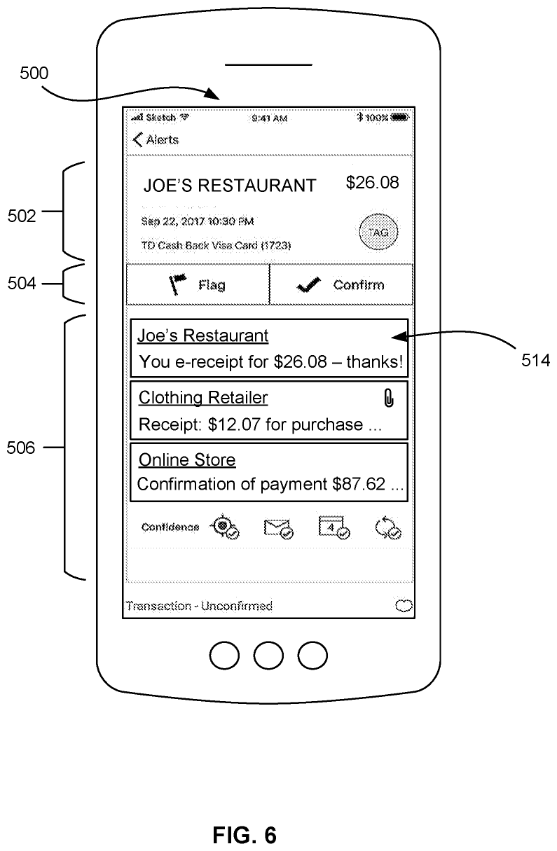

FIG. 6 illustrates the user interface 500 displaying a message 514 to corroborate the transaction. The message 514 is an email including a receipt which corroborates the payment amount of the transaction.

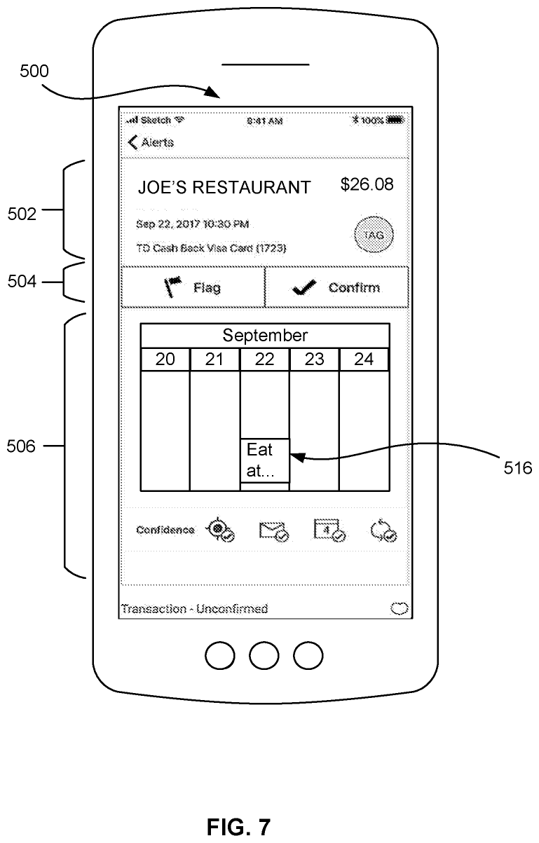

FIG. 7 illustrates the user interface 500 displaying a calendar event 516 to corroborate the transaction. The calendar event 516 corresponds to a time and place of the transaction.

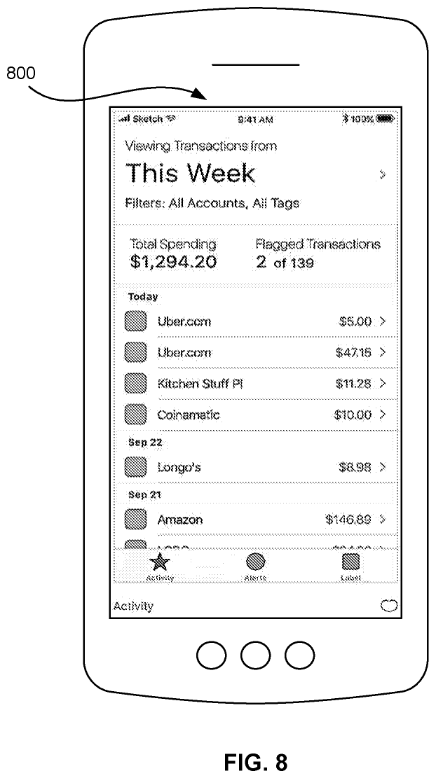

FIG. 8 illustrates an example user interface 800 of a transaction verification application displaying a listing of transactions. In some examples, the list of transactions may include previously recorded transactions and indications of whether the transactions were flag as inauthentic or confirmed to be authentic. In other examples, the list of transactions may include previously confirmed transactions and categories into which the transactions have been designated. Further details of a transaction may be accessed by a user pressing on a listed transaction.

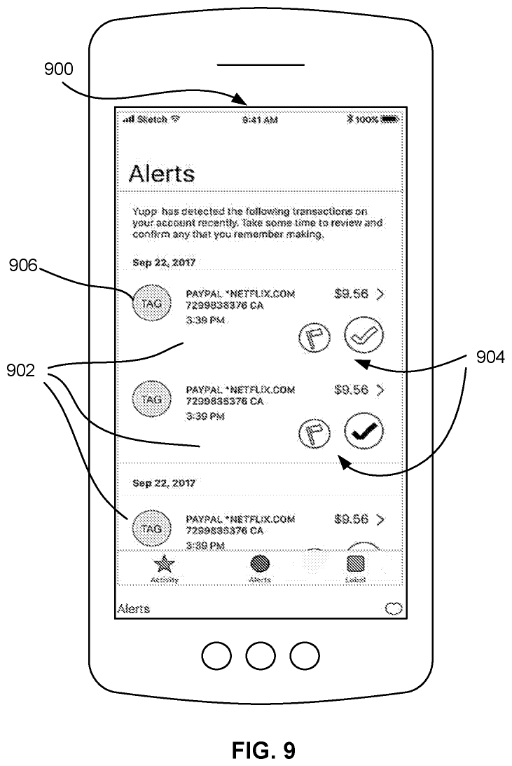

FIG. 9 illustrates an example user interface 900 of a transaction verification application displaying transactions pending verification. The transactions pending verification may be characterized as alerts to draw the attention of the user. The user interface 900 may include listings of transaction entries 902. The transaction entries 902 may be organized by date or another suitable categorization. Details of a transaction, such as payment parameters, may be displayed in the transaction entry. Corroborating information relating to a listed transaction may be accessed by a user pressing on the particular transaction entry. The user interface 900 may include input buttons 904 for selecting whether a pending transaction is to determined to be authentic or inauthentic, the input buttons arranged in proximity to details of the transaction. The user interface 900 may further include categorization buttons 906 for categorizing the transactions.

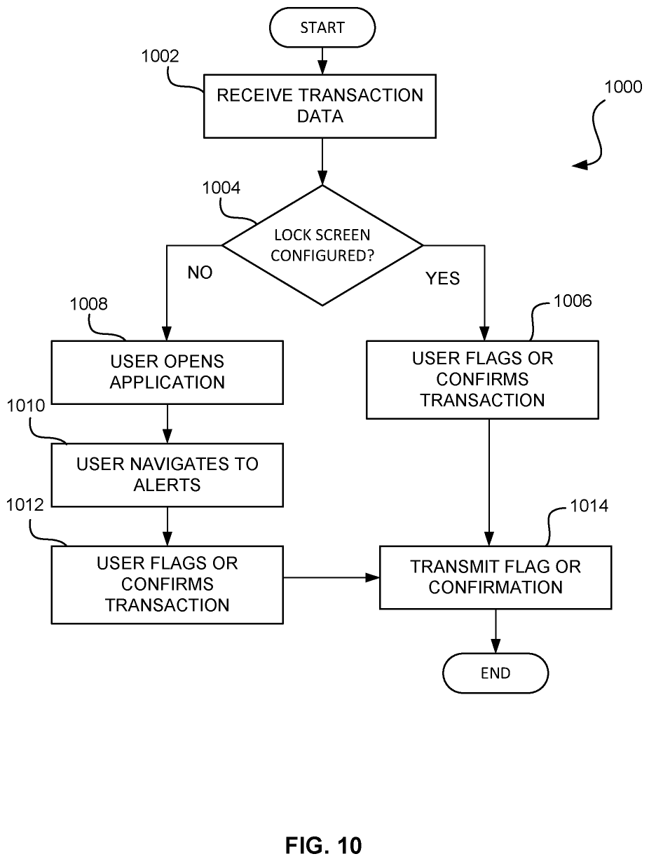

FIG. 10 is a flowchart showing an example method 1000 for flagging an unverified transaction. The method 1000 may be performed at a computing device as discussed herein, such as the computing device 100 of FIG. 4 or the user device 450 of FIG. 4. For purpose of explanation, the method 1000 will be described as being performed at a user device.

At block 1002, a user device receives transaction data indicating that a transaction has been charged against the user's financial account. The transaction data may be packaged in a notification token. The notification token may be received minutes, hours, or days, after the transaction has taken place. The notification token includes basic transaction information describing the transaction which may enable the user to confirm the transaction's legitimacy, such as the identity of the merchant making the charge, the transaction amount, the data and time of the transaction, and the financial account to which the transaction is being charged.

At block 1004, it is determined whether or not the user device is configured to push notifications through its lock screen. Where lock screen interaction is enabled, the user may flag or confirm the transaction at block 1006. Through the lock screen, the user device may display transaction data, and may include input buttons enabling the user to flag or confirm the transaction through the lock screen. For example, where the user device is configured for 3D touch notifications, the user may provide 3D touch input to flag or confirm the transaction. Corroborating data may also be displayed at the lock screen to allow the user to assess the transaction in context.

If the user device is not configured to flag transactions on its lock screen, the user may open a verification application at block 1008, and to an appropriate user interface at block 1010 to view transaction data and corroborating data. At block 1012, the user may flag or confirm the transaction.

At block 1014, a response either confirming or flagging the transaction is transmitted to a transaction verification coordination system. The response may include the user's credentials verifying the identity of the user.

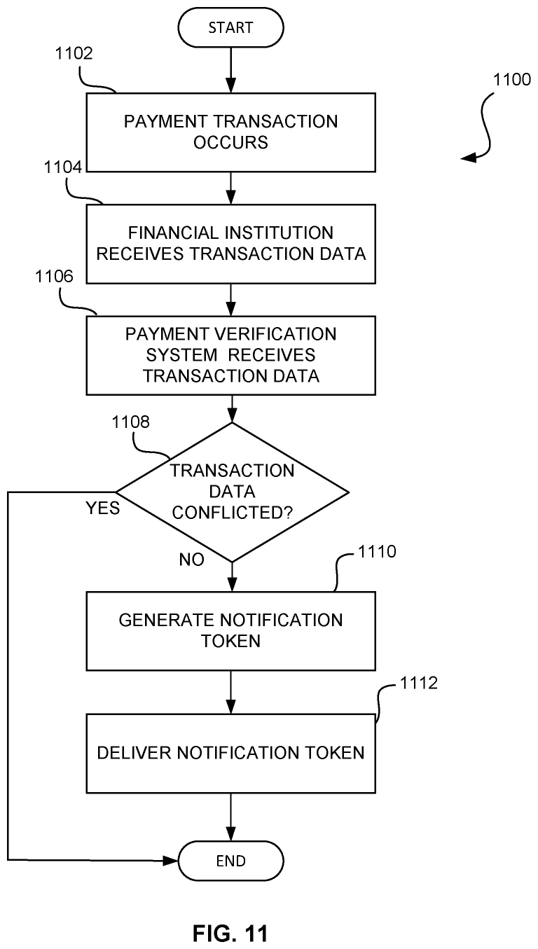

FIG. 11 is a flowchart of an example method for transmitting transaction data to a computing device running a transaction verification application. The method 1100 may be performed by a computing device as discussed herein, such as the transaction verification coordination server 440 of FIG. 4. The method 1100 may be embodied by a set of executable instructions that may be stored in a non-transitory computer-readable medium.

At block 1102, a user makes a transaction. The transaction may be made through a point-of-sale device. The transaction may proceed using a user's credit card, debit card, gift card, mobile device configured to make transactions via a linked credit, debit, or gift card, or by any other electronic means of conducting a transaction at a point-of-sale device. A transaction may be made without a point-of-sale device, such as through an online transactions, including digital payments, stock exchanges, fiat currency exchanges, cryptocurrency exchanges, or any other form of digital payment.

At block 1104, a financial institution system receives transaction data indicating that a transaction should be recorded against a user's financial account.

At block 1106, the transaction verification coordination server receives the transaction data. The transaction data can be received in several ways. For example, where the transaction verification system has webhook support configured with a financial institution, a webhook may push the transaction to the transaction verification coordination server. Where webhook support is not configured, the transaction verification coordination server may scrape databases of the financial institution system, such as through an Application Programming Interface (API) provided by the financial institution system, or an intermediary system, to pull the transaction data.

At block 1108, it is determined whether the transaction data conflicts with more trusted data sources. Where the transaction data is conflicted, the transaction data may be disposed of. Where the transaction data is not conflicted, block 1110 is executed.

At block 1110, where it is determined that the transaction data is not conflicted, a notification token is generated. The notification token may be stored at transaction database at the transaction verification coordination server. Generating the notification token may involve generating a transaction ID for the transaction, compiling transaction data received by the financial institution system, and compiling corroborating data.

Generation of a notification token may be managed by a queue handler to allow for the processing of transactions received from the financial institution system as transactions are received.

At block 1112, the notification token is delivered to the user device. Delivery of the notification token may proceed in a variety of ways depending on the nature and availability of the user device. For example, where the user device is an APPLE® device, delivery may proceed through APPLE PUSH NOTIFICATION SERVICE™, and where the user device is a GOOGLE® device, delivery may proceed by way of GOOGLE CLOUD MESSAGING™. Delivery of notification tokens may proceed by various launch waves, whereby the transaction verification coordination server may confirm availability of a user device to receive a notification token before sending.

A user may review transaction notification tokens and respond to notification tokens through any computer system, such as a mobile device, smartphone, desktop or laptop computer.

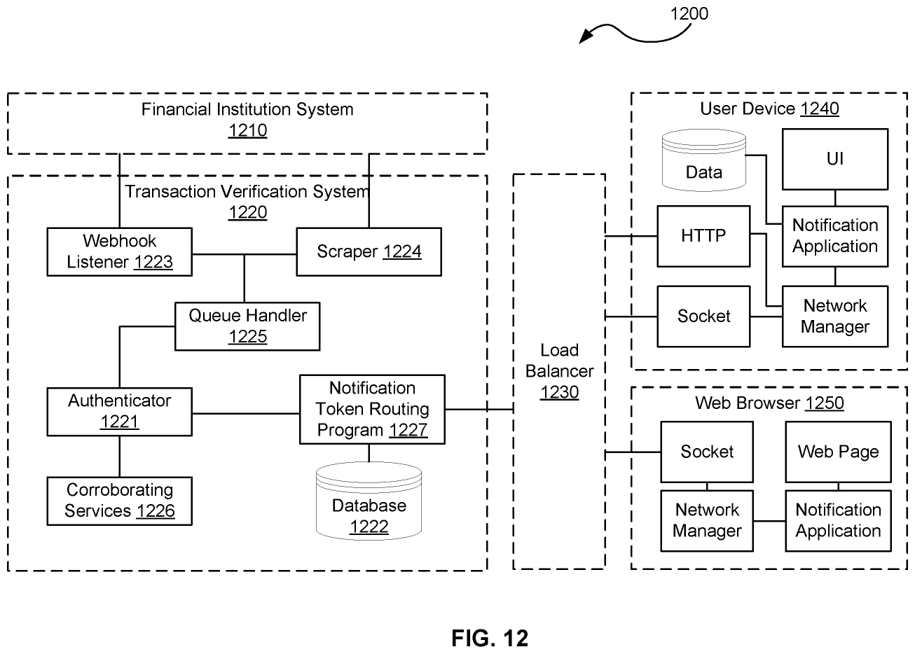

FIG. 12 is a schematic diagram of another example system 1200 for verifying a transaction. The system 1200 includes a financial institution system 1210, transaction verification system 1220, load balancer 1230, user device 1240, a web browser 1250, which may communicate over one or more computer networks. The transaction verification system 1220 may be similar to the transaction verification coordination server 440 of FIG. 4, and thus, for further description, reference may be had to the transaction verification coordination server 440 of FIG. 4. The user device 1240 may be similar to the user device 450 of FIG. 4, and thus, for further description, reference may be had to the user device 450 of FIG. 4.

The transaction verification system 1220 is to access transaction and account datasets from financial institution system 1210 through one or more APIs.

The transaction verification system 1220 includes an authenticator 1221 to allow users to authenticate their identity, for confirming or flagging transactions, using a digital credential system, such as MICROSOFT® PASSPORT™.

The transaction verification system 1220 includes a relational database 1222. Various storage designs may be implemented in database 1222, including PostgreSQL, Redis, or other designs.

The transaction verification system 1220 includes a webhook listener 1223 and a scraper 1224 to process bank transactions and transpose them into a common model, on a schedule. The webhook listener 1223 links with an affiliated financial institution system 1210 to aggregate transaction information for users linked through service providers, such as PLAID™, where transaction data is received through webhooks, mapped into a common model, and transactions are placed into a transaction queue on queue handler 1225. The scraper 1224 links with an affiliated financial institution system 1210 to scrape data from a service provider such as FLINKS™ on a pre-determined schedule, which is normalized into a common model for placement into a transaction queue on queue handler 1225. A pre-determined scraping schedule may be set by a LINUX® utility.

The transaction verification system 1220 includes a queue handler 1225 configured to process transactions as they are received through webhook listener 1223 or scraper 1224. The queue handler 1225 makes the necessary database calls to add or modify transaction data stored in database 1222. In some embodiments, the queue handler 1225 may cause push notifications to be transmitted to user device 1240, through push notification services such as APPLE® PUSH NOTIFICATION SERVICES™, where the user device includes an iOS® device.

The transaction verification system 1220 includes corroborating services 1226 where corroborating data received for inclusion into a notification token.

The transaction verification system 1220 includes a notification token routing program 1227 in communication with the authenticator, database 1222, and load balancer 1230, which generates a notification token including transaction data and corroborating data and routes the notification token to a user for verification.

The load balancer 1230 distributes network traffic, including transmission of notification tokens, across multiple servers, for transmission to user systems including user device 1240 and web browser 1250.

The user device 1240 may be operated by a, to communicate with the transaction verification system 1220 to receive notification tokens and verify transactions by responding to verification tokens. The user device 1240 may receive notification tokens through a hyper text transfer protocol (HTTP) or socket at a network manager for processing by a notification application, stored, and display to a user through a user interface.

The web browser 1250 may receive notification tokens through a socket at a network manager for processing by a notification application and displayed to a user through a web page.

In operation, the system 1200 gathers financial transaction data from a financial institution system 1210 and generates a notification token for delivery to a user through user device 1240 or web browser 1250 to allow the user to confirm that the transaction is authentic or flag the transaction as inauthentic.

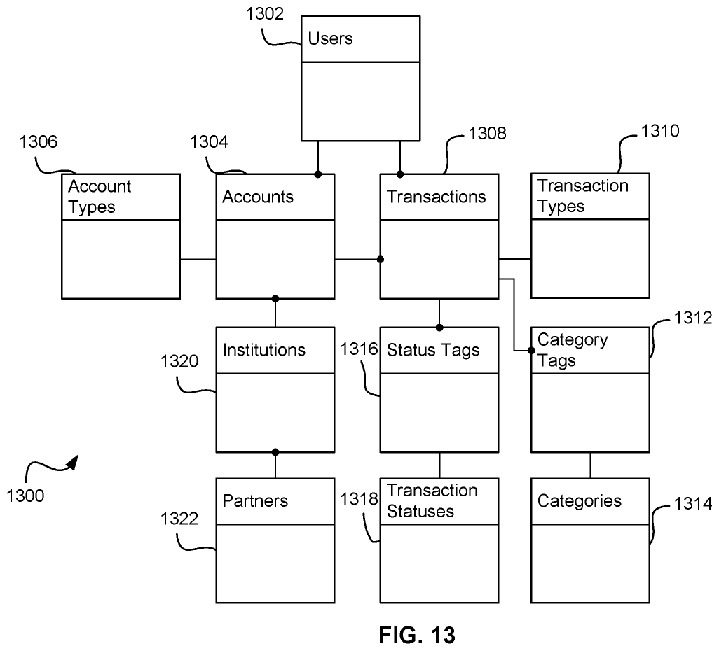

FIG. 13 is a schematic diagram of an example database structure 1300 of a system for verifying a transaction. The database structure 1300 includes several tables of data serving as the infrastructure for the management of transactions to be verified by a transaction verification system. Thus, the database structure 1300 may be incorporated into a database of a transaction verification system, such as the database 1222 of the transaction verification system 1220 of FIG. 12, or a database of the transaction verification coordination server 440 of FIG. 4. Although a single database structure 1300 is described, it is understood that database structure 1300 may refer to databases and/or datastores distributed across a combination of computers and/or servers, such as in a cloud computing environment.

Database structure 1300 includes users table 1302, accounts table 1304, transactions table 1308, transaction types table 1310, category tags table 1312, categories table 1314, status tags table 1316, transaction statuses table 1318, institutions table 1320, and partners table 1322.

Users table 1302 includes attributes for a user ID, contact information, and personal identifying information. Each user may be related to one or more accounts, and may be related to one or more transactions.

Accounts table 1304 includes attributes for an account ID, an ID for the financial institution where the account is held, account balance, and other information related to a financial account. Each account may be related to one account type.

Account types table 1306 includes enumerations of different account types, including depository, brokerage, credit, mortgage, loan, or other financial accounts.

Transactions table 1308 includes attributes for a transaction ID, timestamp, location, pending status, payee name, and associated bank IDs and account IDs. Each transaction may be related to a particular transaction type, and to one or more category tags.

Transaction types table 1310 includes enumerations of different transaction types, including place transactions, digital transactions, special transactions, unresolved transactions, and other financial transactions.

Category tags table 1312 includes attributes for categories and category labels. Each category tag may be associated with a category.

Category table 1314 includes enumerations of different transaction categories, including business, user, and other transaction categories.

Status tags table 1316 includes attributes for transaction statuses, and transaction priorities. Each status tag may be related to a transaction status.

Transaction statuses table 1318 includes enumerations of different transaction statuses, including user-verified, user-flagged, GPS-verified, GPS-flagged, calendar-verified, email-verified, and other forms of verification.

Institutions table 1320 includes attributes for an institution ID, institution name, institution webhook, and associated partner ID. Each institution may be related to one or more accounts.

Partners table 1322 includes attributes for a partner ID, partner name, confidence ranking, access token, and public token. Each partner may be related to one or more institutions.

The database structure 1300 described herein is one example of how a database structure for storing transaction data and other related data may be stored in a system for verifying transactions. It is to be understood that other database designs, involving more or fewer tables, different attributes, and different linkages, may be employed, to facilitate the systems and methods described herein.

It should therefore be seen that methods, systems, and devices for verifying transactions which may be provided which incorporate a user verification step to add greater certainty to the authenticity of transactions. Verification of a transaction is provided by a user having the benefit of corroborating data gathered automatically and presented to them appropriately to assist the user in verifying the transaction. Such reliable verification may be incorporated into existing information management systems to improve overall security and confidence in digital financial transaction records.

In addition, the system described herein may be applied in a distributed ledger system, including blockchain technology, whereby a user's verification of a transaction is added to a distributed ledger.

While the implementations discussed herein are directed to specific implementations of the system, it will be understood that combinations, sub-sets, and variations of the implementations are within the scope of the present disclosure.

The scope of the claims should not be limited by the embodiments set forth in the above examples, but should be given the broadest interpretation consistent with the description as a whole.

1. A non-transitory computer-readable medium comprising instructions to:
obtain transaction data indicating execution of a transaction, the transaction data including payment parameters of the transaction;
obtain corroborating data relevant to a determination of whether the transaction is authentic or inauthentic;
display the payment parameters and indications of the corroborating data through a user interface of a computing device; and
receive a selection through the user interface to indicate that the transaction is determined to be authentic or inauthentic.

2. The non-transitory computer-readable medium of claim 1, wherein the transaction data indicates that the transaction was executed at a particular point-of-sale device at a particular time, the corroborating data includes a location of the particular point-of-sale device and a location of the computing device at the particular time, and the instructions are further to display through the user interface an indication of the location of the particular point-of-sale device and the location of the computing device at the particular time.

3. The non-transitory computer-readable medium of claim 2, wherein the instructions are further to display through the user interface an indication of whether the location the computing device was proximate to the particular point-of-sale device at the particular time.

4. The non-transitory computer-readable medium of claim 1, wherein the corroborating data includes a message having contents or metadata which corroborates a payment parameter of the transaction, and the instructions are further to display through the user interface an indication of whether the contents or metadata of the message corroborate the transaction.

5. The non-transitory computer-readable medium of claim 4, wherein the message includes a transaction receipt which corroborates a payment amount of the transaction.

6. The non-transitory computer-readable medium of claim 1, wherein corroborating data includes a calendar event corresponding to a time of execution of the transaction, and the calendar event having contents or metadata which corroborates a payment parameter of the transaction.

7. The non-transitory computer-readable medium of claim 1, wherein the instructions are further to:
receive input through the user interface to designate that the transaction belongs to a selected category of transactions; and
display through the user interface an indication that the transaction belongs to the selected category of transactions.

8. The non-transitory computer-readable medium of claim 1, wherein the instructions are further to:
in response to receiving a selection that the transaction is inauthentic, transmit a message to a financial institution system to indicate that a selection that the transaction is inauthentic has been made.

9. The non-transitory computer-readable medium of claim 1, wherein the instructions are further to:
prompt a user of the computing device to make a selection to indicate h the transaction is determined to be authentic or inauthentic.

10. The non-transitory computer-readable medium of claim 1, wherein the instructions are further to:
monitor transaction data for a revision to a payment parameter of the transaction; and
in response to identifying a revision to a payment parameter, prompt a user of the computing device to make a selection to indicate that the revision is determined to be authentic or inauthentic.

11. The non-transitory computer-readable medium of claim 1, wherein the instructions are further to:
obtain an image of a receipt generated from the transaction;
identify text on the receipt of the transaction;
analyze the text on the receipt for a payment parameter on the receipt; and
display through the user interface an indication of whether the payment parameter on the receipt corroborates a payment parameter of the transaction.

12. The non-transitory computer-readable medium of claim 11, wherein the computing device includes a camera, and the instructions are further to:
prior to obtaining the image of the receipt generated from the transaction, prompt a user of the computing device to capture the image using a camera of the computing device.

13. The non-transitory computer-readable medium of claim 1, wherein the instructions are further to:
in response to receiving a selection through the user interface to indicate that the transaction is inauthentic, generate a template message directed to a financial institution system to indicate that a selection that the transaction is inauthentic has been made.

14. A method to coordinate verification of authenticity of a transaction, the method comprising:
obtaining transaction data indicating execution of a transaction, the transaction data including payment parameters of the transaction;
transmitting the transaction data to a user device for display through a user interface of the user device, the user interface to display the payment parameters and indications of corroborating data, the corroborating data relevant to a determination of whether the transaction is authentic or inauthentic; and
receiving a selection from the user device to indicate whether the transaction is determined to be authentic or inauthentic, the selection made based at least in part on analysis of the corroborating data.

15. The method of claim 14, further comprising:
obtaining the corroborating data; and
transmitting the corroborating data to the user device.

16. The method of claim 14, wherein the transaction data is obtained from a financial institution system.

17. The method of claim 14, wherein the transaction data is obtained through a webhook listener connected to the financial institution system.

18. The method of claim 14, further comprising generating a targeted advertisement based on the transaction data.

19. A computing device comprising:
a display and input device to enable operation of a user interface; and
a set of instructions to:
obtain transaction data indicating execution of a transaction, the transaction data including payment parameters of the transaction;
obtain corroborating data relevant to a determination of whether the transaction is determined to be authentic or inauthentic;
display the payment parameters and indications of the corroborating data through the user interface; and
receive a selection through the user interface to indicate that the transaction is authentic or inauthentic.

20. A method to verify authenticity of a transaction, the method comprising:
obtaining transaction data indicating execution of a transaction, the transaction data including payment parameters of the transaction;
obtaining corroborating data relevant to a determination of whether the transaction is authentic or inauthentic;
displaying the payment parameters and indications of the corroborating data through a user interface of a computing device; and
receiving a selection through the user interface to indicate that the transaction is determined to be authentic or inauthentic.

21. A transaction verification coordination server comprising;
a communication interface; and
a set of instructions to:
obtain transaction data indicating execution of a transaction, the transaction data including payment parameters of the transaction;
transmit the transaction data to a user device for display through a user interface of the user device, the user interface to display the payment parameters and indications of corroborating data, the corroborating data relevant to a determination of whether the transaction is authentic or inauthentic; and
receive a selection from the user device to indicate whether the transaction is determined to be authentic or inauthentic, the selection made based at least in part on analysis of the corroborating data.

22. A non-transitory computer-readable medium comprising instructions to:
obtain transaction data describing a transaction;
transmit the transaction data to a user device for display through a user interface of the user device, the user interface to display the transaction data and corroborating data relevant to a determination of whether the transaction is authentic or inauthentic; and
receive a selection from the user device to indicate whether the transaction is determined to be authentic or inauthentic, the selection made based at least in part on analysis of the corroborating data.
